(19) United States
(12) Patent Application Publication
(10) Pub. No.: US 2013/0166184 A1
(43) Pub. Date: Jun. 27, 2013

(54) METHOD AND DEVICE FOR SETTING AN EMERGENCY OPERATIONAL MODE IN A SYSTEM WHICH DETECTS PRE-IGNITIONS IN A COMBUSTION ENGINE, AND WHICH CONTAINS ERRORS

(71) Applicants: Juergen Wuerth, Freiberg (DE); Carsten Kluth, Stuttgart (DE); Werner Haeming, Neudenau (DE); Li Luo, Stuttgart (DE)

(72) Inventors: Juergen Wuerth, Freiberg (DE); Carsten Kluth, Stuttgart (DE); Werner Haeming, Neudenau (DE); Li Luo, Stuttgart (DE)

(73) Assignee: ROBERT BOSCH GMBH, Stuttgart (DE)

(21) Appl. No.: 13/820,443

(22) PCT Filed: Aug. 1, 2011
(86) PCT No.: PCT/EP2011/063200

§ 371 Date: Mar. 1, 2013

(30) Foreign Application Priority Data
Sep. 6, 2010 (DE) 102010040271.0

(51) Int. Cl. F02D 43/04

(52) U.S. Cl. CPC F02D 43/04
USPC 701/111

(57) ABSTRACT

The invention relates to a method for setting an emergency operational mode in a system which detects pre-ignitions in a combustion engine and which contains errors. The system consists of at least one sensor (17) and/or at least one sensor cable (24) and/or a sensor signal evaluation device (20), and is subject to a diagnosis to detect an error. In order to prevent damage to the combustion engine if the system for detecting pre-ignitions does contain an error, a standard path (26), which comprises sensor signal capturing, sensor signal evaluation, detection of pre-ignitions and initiation of measures to counter the pre-ignitions, is interrupted when the diagnosis detects an error in the system (17, 24, 29), and a safety path (27) is activated as an emergency operational mode.

### BACKGROUND OF THE INVENTION

The invention relates to a method for detecting an emergency operational mode in a system which detects pre-ignition in a combustion engine and which contains errors, wherein, in order to detect an error, the system, consisting of at least one sensor and/or at least one sensor cable and/or a sensor signal evaluation device, is subjected to a diagnosis; the invention also relates to a device for carrying out the method.

In a combustion engine, a combustion of the fuel-air mixture supplied causes the vehicle to be set into driving operation or to maintain driving operation. In this case the combustion of the fuel-air mixture is initiated by the ignition spark of a spark plug. The ignition spark builds up a flame front which spreads throughout the combustion chamber of the combustion engine and converts the fuel-air mixture present into kinetic energy during combustion. In the case of knocking combustion, some of the combustions occur abruptly and cause a sharp pressure increase in the combustion chamber of the combustion engine, generating a pressure wave which is propagated and impinges on the walls delimiting the combustion chamber, where the high-frequency oscillations are converted into structure-borne noise. These oscillations are detected by knock sensors (structure-borne noise sensors) and are taken into account in the control system of the combustion engine by a knock control system in order to prevent engine damage. In this case the combustion engine is always operated at the knock limit for optimum efficiency. With the aid of the knock control system damage to the combustion engine by the constantly recurring knocking combustion is avoided.

However, in addition to the knocking combustion described, self-ignition caused by hot points in the combustion chamber, oil droplets or hot residual gas zones in the fuel-air mixture also occur. Such self-ignition may occur as pre-ignition before the appearance of the ignition spark and as post-ignition after the appearance of the ignition spark. In this case one or more further flame fronts are produced in addition to the flame front induced by the ignition spark. This self-ignition is usually referred to as pre-ignition and increases the danger of knocking combustion in the final gas region. The structure-borne noise oscillations which occur in this case are distinguished by extreme pressure amplitudes which can lead very quickly to engine damage.

Through evaluation of the signals of the knock sensor, the combustion engine is monitored to determine whether uncontrolled combustion is occurring. To suppress this uncontrolled combustion, countermeasures preventing the occurrence of pre-ignition are initiated, since the engine must be protected against this pre-ignition. In this case it is not sufficient, as with knock control, to retard the ignition angle, since the self-ignition is not influenced by the spark plug. For this reason, other measures which lower the mixture temperature in the combustion chamber are necessary, for example reducing the charge in the combustion chamber of the combustion engine.

Such a path for pre-ignition includes as further hardware, in addition to the knock sensor, at least one sensor cable and a sensor signal evaluation device. However, if a fault occurs in one of the hardware elements the signal for detecting pre-ignition yields an incorrect result. In this case the ensuing measures for preventing pre-ignition cannot prevent damage to the engine, since they have been initiated on incorrect assumptions. For this reason the hardware elements, such as the knock sensor, sensor cable and sensor signal evaluation unit, are subjected to constant diagnosis.

### SUMMARY OF THE INVENTION

It is therefore the object of the invention to specify a method and a device for setting an emergency operational mode in a system which detects pre-ignition in a combustion engine and which contains errors, which method and device reliably prevent damage to the combustion engine in the event of faulty hardware.

According to the invention, the object is achieved in that, upon detection of an error in the system by the diagnosis, a standard path, which comprises sensor signal capture, sensor signal evaluation, detection of uncontrolled combustion and initiation of measures to counter the pre-ignition, is interrupted and a safety path is activated as an emergency operational mode. This has the advantage that all the connections to the combustion engine which are built up when the pre-ignition detection system operates correctly are interrupted. A separate safety path is built up, by means of which the combustion engine is transferred to an emergency operational mode with respect to the prevention of pre-ignition. Every normal connection to the combustion engine is therefore also interrupted, ensuring the protection thereof. In this emergency operational mode in which detection of pre-ignition is no longer possible, an emergency operational measure for protecting the combustion engine which reliably prevents further pre-ignition from occurring is initiated.

In one configuration, measures are activated in the safety path which reliably prevent the occurrence of pre-ignition in the combustion engine. Through such measures it is always ensured in principle that pre-ignition is prevented even if no definite measurement signals indicate the presence or emergence of pre-ignition. In this case the combustion engine is placed in a condition which does not permit pre-ignition.

In a development, a temperature in a combustion chamber of the combustion engine is lowered in order to prevent the occurrence of pre-ignition. This has the advantage that the abrupt and extremely engine-damaging energy conversion in the combustion chamber is reduced or entirely prevented. Hot points in the combustion chamber or hotspots in the fuel-air mixture are thereby cooled and the occurrence of pre-ignition is therefore prevented.

In a variant, the temperature in the combustion chamber of the combustion engine is lowered by a fuel enrichment in the combustion engine. By enriching the fuel-air mixture contained in the combustion chamber of the combustion engine, the combustibility is limited by the practically constant air mass. Furthermore, the force-air mixture is cooled more strongly by the vaporization of the larger fuel quantity which takes place.

In another configuration, the temperature in the combustion chamber of the combustion engine is lowered by an air enrichment in the combustion engine. In this case the air quantity participating in combustion has a cooling effect. In addition, the lean mixture leads to slower propagation of combustion throughout the fuel-air mixture, so that pre-ignition has less effect on the combustion engine.

In a further variant, the temperature in the combustion chamber of the combustion engine is decreased by lowering the charging of the petrol engine by reducing the air supply. This is effected by moving the throttle valve in the direction of the closed state, whereby further ingress of air into the combustion chamber is prevented and combustion is therefore reduced, which also has a positive effect on pre-ignition as a result of lower temperatures.

Advantageously, the temperature in the combustion chamber of the combustion engine is lowered by reducing an internal residual gas in the combustion engine by means of small overlap in the timing of the inlet and/or exhaust valves of the combustion engine. Adjustable camshafts are a precondition for these adjustments. In this case, at least one camshaft of the inlet or exhaust valves must be adjustable. It is advantageous if both camshafts are adjustable, so that the timing for the inlet and exhaust valves is adjustable. This procedure makes possible a very versatile reaction to pre-ignition, since the overlaps can be quickly adjusted by means of software. Since the inlet valve is only opened while the exhaust valve is already closed, the temperature in the combustion chamber of the combustion engine is lowered. Reduction of the overlap in the timing may be based on the maximum strokes of the inlet or exhaust valve, or only certain opening states of the valves may be taken into account.

In a development, for diagnosis of the sensor a standardized reference level is formed and, in order to detect errors, is compared with an upper and a lower threshold value, an error being detected if the sensor signal lies outside the signal band formed by the upper and the lower threshold value over the engine speed. This diagnosis is very simple to carry out and requires only a change in the software. The use of additional hardware can be dispensed with.

In particular, for diagnosis of the sensor cable a short-circuit test is carried out and, if a short circuit of the sensor cable to a battery voltage or to an earth is present, an error is detected. This diagnostic measure, too, can be carried out very simply during operation of the combustion engine.

In a development, the diagnosis of the sensor signal evaluation device is carried out by monitoring the computer hardware with regard to signal capture and signal evaluation, an error being detected if implausibilities occur during the signal capture or signal evaluation. This diagnosis, too, is carried out during operation of the sensor signal evaluation device, leading to rapid detection of the error in the sensor signal evaluation device.

In a further embodiment, the error is stored in an error memory for evaluation in a workshop. The errors which have been detected during operation of the combustion engine can therefore also be corrected retrospectively .

A development of the invention concerns a device for setting an emergency operational mode in a system which detects pre-ignition in a combustion engine and which contains errors, wherein the system, consisting of at least one sensor and/or a sensor cable and/or a sensor signal evaluation device is subjected to a diagnosis in order to detect an error. To prevent damage to the combustion engine if the detection of pre-ignition malfunctions, means are present which, upon detection by the diagnosis of an error in the system, interrupt or completely or partially switch off a standard path, comprising sensor signal capture, sensor signal evaluation, detection of pre-ignition and initiation of measures to counter the pre-ignition, and activate a safety path as an emergency operational mode. Because the path normally used to detect pre-ignition is completely switched off, it is ensured that no damage to the combustion engine occurs, since only measures which in all cases prevent the occurrence of pre-ignition are implemented in the safety path.

Advantageously, the means include a control and evaluation device for the combustion engine which triggers signals for a diagnosis of the at least one sensor and/or the at least one sensor cable and/or the sensor signal evaluation device and which evaluates the response signals received in dependence on these signals, the standard path (26), comprising sensor signal capture, sensor signal evaluation, detection of uncontrolled combustion and initiation of measures to counter pre-ignition, being interrupted upon detection of an error and the safety path being activated. Such switching off of the standard path and activation of the safety path can be implemented in a simple manner in the software of the control and evaluation device. The activation of a separate safety path guarantees that only measures which reliably guarantee the safety and protection of the combustion engine are carried out on the combustion engine if a system containing errors is detected.

In a variant, the sensor is a knock sensor arranged on the cylinder of the combustion engine, a pressure sensor arranged in the combustion chamber of the combustion engine or a rotational speed sensor detecting the rotational speed of the crankshaft of the combustion engine. By means of these different sensors, uncontrolled combustion can be reliably detected. In this case pre-ignition is detected directly if the pressure sensor is used, whereas the use of the knock sensor, or detection via rotational speed information, entails indirect detection of pre-ignition.

In one configuration, each cylinder of the combustion engine has, as actuators, an inlet valve for admitting air and an exhaust valve for discharging a combustion waste gas, the opening times of which are set in each case by a camshaft, the control and evaluation device activating the camshafts in such a way that the opening times of the inlet and exhaust valves do not overlap or overlap only slightly. By reducing the overlap of the opening times, the internal residual gas contained in the combustion chamber of the combustion engine is reduced, whereby the temperature level in the combustion chamber is lowered. In this case the activation of the inlet and exhaust valves of a cylinder with less overlap represents a simple measure in terms of software.

### BRIEF DESCRIPTION OF THE DRAWINGS

The invention admits numerous embodiments. One of them will be explained in more detail with reference to the figures shown in the drawing, in which:

FIG. 1 shows a device for detecting and reducing uncontrolled combustion in a combustion engine;

FIG. 2 is a schematic representation of a cylinder of the combustion engine according to FIG. 1, and

FIG. 3 shows paths for activating the combustion engine in the event of uncontrolled combustion.

### DETAILED DESCRIPTION

Like features are designated by the same reference numerals.

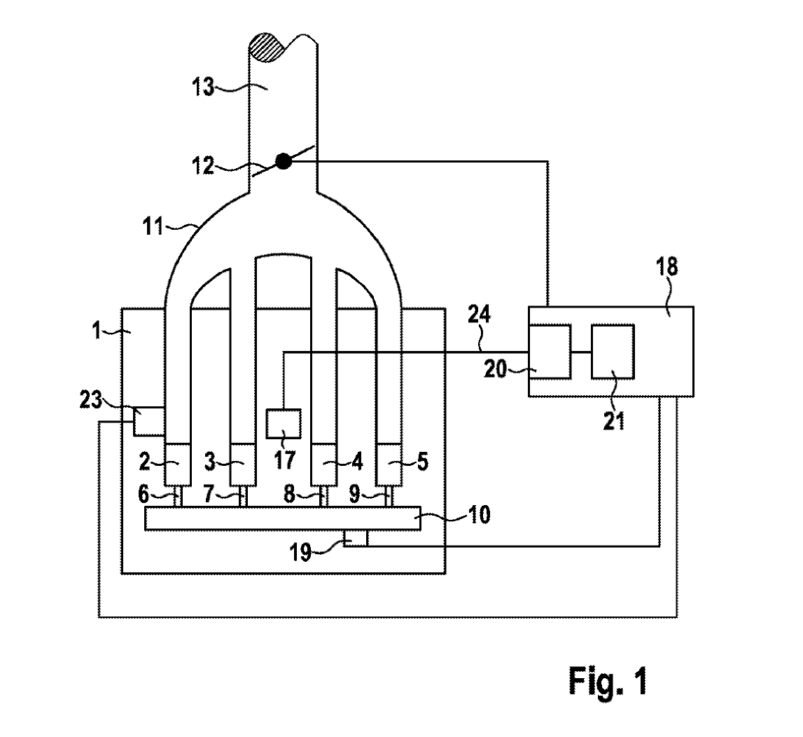

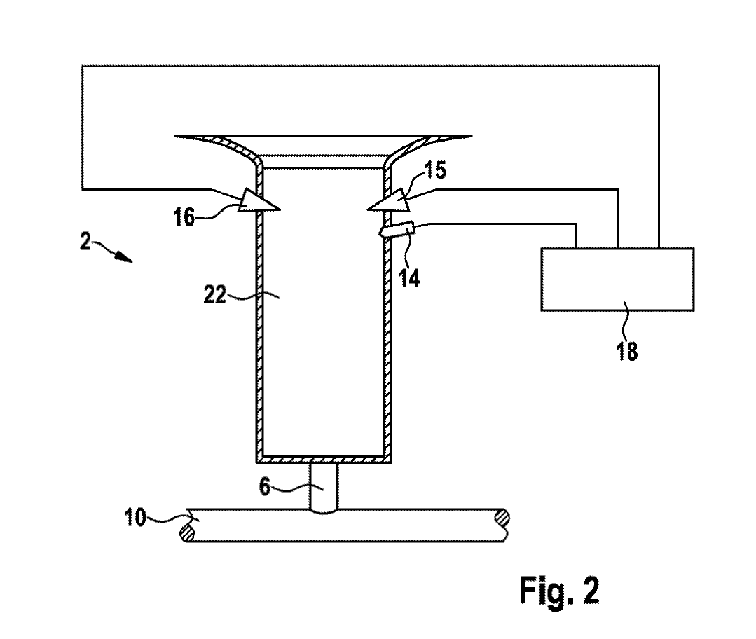

FIG. 1 shows a device for detecting and evaluating a combustion in an internal combustion engine 1. In this example the combustion engine 1 has four cylinders 2, 3, 4, 5 having pistons (not shown in detail) which move in the cylinders 2, 3, 4, 5, are connected by means of respective connecting rods 6, 7, 8, 9 to the crankshaft 10, which they drive as a result of the pressure changes caused by the combustion. The cylinders 2, 3, 4, 5 are connected to an inlet manifold 11 which is closed by a throttle valve 12 with respect to an air intake pipe 13. A nozzle 14 for injecting fuel projects into each cylinder 2, 3, 4, 5, whereby a fuel-air mixture is formed. In addition, each cylinder 2, 3, 4, 5 has an inlet valve 15 for fresh air and an exhaust valve 16 for the exhaust gases produced during the combustion process, as is represented by way of example only for cylinder 2 in FIG. 2. The inlet valve 15 is driven by an inlet camshaft and the exhaust valve 16 by an exhaust camshaft, which are not shown in detail for the sake of clarity.

A knock sensor 17, which detects the structure-borne noise oscillations of the combustion engine 1 which are caused by the combustion in the internal combustion engine 1, is arranged on the combustion engine 1. The signals of the knock sensor 17 are transmitted to a control unit 18 which is also connected to a crankshaft sensor 19 located opposite the crankshaft 10, the control unit 18 allocating the combustions to the signal of the crankshaft sensor 19, which signal presents a crankshaft angle. The control unit 18 includes a sensor evaluation device 20 which is connected to a memory 21.

In addition, the control unit 18 is connected to the throttle valve 12, to the fuel injector nozzle 14, to the inlet valve 15 and to the exhaust valve 16 of each cylinder 2, 3, 4, 5 via the camshaft adjustment system. To detect the first cylinder, a phase sensor 23, which is also connected to the control unit 18, is mounted on the first cylinder 2.

When the throttle valve 12 is opened, fresh air flows into the inlet manifold 11 and is introduced into the cylinder 2, 3, 4, 5 via the inlet valve 15. In addition, fuel is injected into the cylinders 2, 3, 4, 5 by the respective fuel injector nozzle 14. A combustion is initiated successively in the cylinders 2, 3, 4, 5 by means of a spark triggered by a spark plug (not shown in detail), causing a pressure rise in the cylinder 2, 3, 4, 5 which is transmitted via the piston and the connecting rod 6, 7, 8, 9 to the crankshaft 10, setting it in motion. In addition to controlled combustion, which as a rule is knock-free and may knock only in isolated cases, combustions occur which have a very early start of combustion or very early combustion positions. These combustions are referred to as pre-ignition. In comparison to normal combustion, such pre-ignition has substantially higher pressures and temperatures, which are harmful to the combustion engine. To detect and reduce pre-ignition, a signal evaluation path for detecting pre-ignition is set up in the control unit 18. In this case the signals of the knock sensor 17 occurring as a result of the structure-borne noise oscillations caused by the combustion are evaluated continuously or at predetermined time intervals. These output signals of the knock sensor 17 are placed in relation to the crankshaft angle output by the crankshaft sensor 19 by the control unit 18. The knocking combustions can thereby be allocated to the respective cylinders 2, 3, 4, 5 in which the combustions take place.

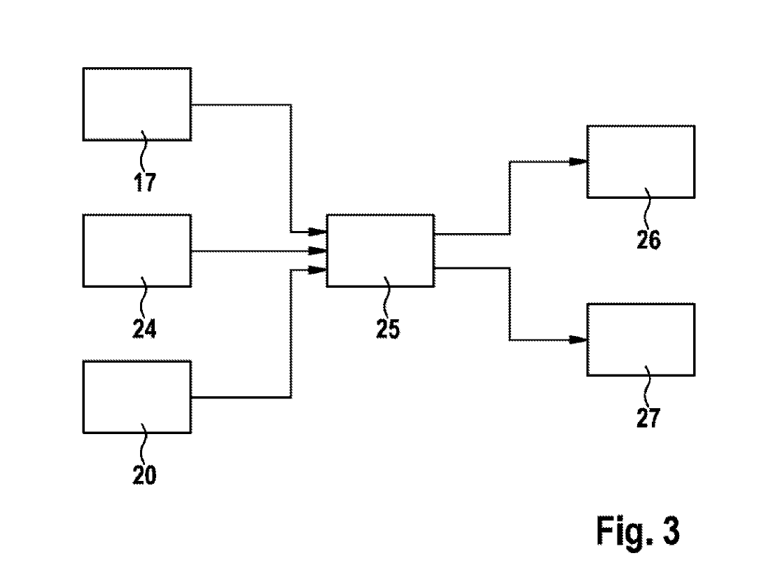

In order to ensure that the necessary hardware for detecting pre-ignition is always working reliably, this hardware is subjected to diagnosis at regular intervals. In addition to the knock sensor 17, this hardware includes the sensor cable 24 connecting the knock sensor 17 to the control unit 18, and the control unit 18 itself as the signal evaluation unit. In this case the diagnosis is performed by means of a software program and contains a logic block 25. This logic block 25 is represented in FIG. 3.

To diagnose a sensor error, a signal band is formed from an upper and a lower threshold value, it being necessary for an intact signal of the knock sensor 17 to lie within the signal band. If this signal supplied by the knock sensor 17 lies outside the signal band, an error is detected.

To this end, the sensor cable 24 itself is subjected to a diagnosis in which a short-circuit test of the cable 24 is carried out. In such a short-circuit test it is determined whether the sensor cable 24 has a short circuit either to earth or to a battery voltage. If this is the case, this is also registered as an error in the logic block 25 and stored in the memory 21.

To diagnose the sensor signal evaluation device 20, the computer hardware of the sensor signal evaluation device 20 is monitored with respect to signal capture and signal evaluation, an error being detected if implausibilities have occurred during signal capture or signal evaluation. This error is also stored in the memory 21 in the logic block 25 of the monitoring software. The errors stored in the memory 21 can at any time be output in a workshop for further diagnostic purposes and evaluated.

If an error has been detected in one of the three diagnosis cases, the standard path 26 which has existed up to now for the combustion engine 1 is switched off. This switching-off may be carried out, on the one hand, in that detection of pre-ignition by the sensor signal evaluation device 20 in the control unit 18 is interrupted. It is thereby ensured that no measures for suppressing pre-ignition are carried out. In addition to switching off the detection of pre-ignition, however, it is also possible that all countermeasures for preventing pre-ignition are ended. This measure also ensures that the actuators 12, 14, 15, 16 of the combustion engine 1 cannot receive any requests for further activities via the standard path 26.

In the event of an error, a second, separate safety path 27, which comprises safety measures for preventing damage to the combustion engine 1, is activated. These safety measures are procedures which ensure that the temperature in the combustion chamber of the combustion engine is always kept sufficiently low that an occurrence of uncontrolled combustion is reliably prevented.

To protect the combustion engine 1 against the occurrence of pre-ignition, different measures for preventing pre-ignition are initiated in the safety path 27. These measures may be carried out either singly or in combination. They include cooling of the combustion chamber 22 of the cylinders 2, 3, 4, 5 by a fuel enrichment or a fresh air enrichment or a charge reduction.

Pre-ignition can be especially conveniently reduced by decreasing the internal residual gas in the cylinder 2, 3, 4, 5. In this case the inlet valve 15 and the exhaust valve 16 are actuated by their camshafts in such a way that the opening times of both valves 15, 16 do not overlap at TDC (top dead centre) in the charge exchange. In this case the camshafts are activated by the control unit 18, in exactly the same way as the throttle valve 12 to reduce the air supply, and the fuel injection valve 14. The reduced valve overlap causes the inlet valve 15 to be opened only when the exhaust valve 16 is closed, whereby the residual gas contained in the cylinder 2, 3, 4, 5 is reduced and the temperature level in the cylinder 2, 3, 4, 5 falls. If only the inlet camshaft is variably adjustable, the timing for the exhaust valve 15 is retarded. This means that the inlet valves 15 only open when the piston of the respective cylinder 2, 3, 4, 5 has already passed top dead centre (TDC), which represents the highest point the piston in the cylinder 2, 3, 4, 5 can reach, and is already in a downward movement. If the combustion engine 1 has only adjustable exhaust valve timing, the timing of the exhaust valves is set to advanced, that is, to before the piston of the cylinder 2, 3, 4, 5 reaches top dead centre (TDC) in its upward movement. If both the inlet valves 15 and the exhaust valves are variable, the timing of the exhaust valves 16 is advanced and that of the inlet valves 15 is retarded. In this case both the maximum strokes of the valves 15, 16 or only a certain A in the opening of the valves 15, 16 may be taken into account.

Further possibilities for initiating the measures for preventing pre-ignition by the control unit 18 are also contained in the safety path 27. Thus, in a simple variant, one or more of the possibilities already discussed may be triggered by the control unit 18, either by activating the fuel injector nozzle 14 and/or by adjusting the throttle valve 12 and/or by varying the timing of the inlet valve 15 and the exhaust valve 16.

1. A method for activating an emergency operational mode in a system which detects pre-ignition in a combustion engine and which contains a fault, wherein, in order to detect the fault, the system, which of includes at least one sensor, is subjected to a diagnosis, characterized in that, if a fault in a standard path (26) of the system (17, 24, 20) is detected by the diagnosis, a safety path (27) is activated as an emergency operational mode.

2. The method as claimed in claim 1, characterized in that, in the safety path (27), measures which reliably prevent the occurrence of pre-ignition in the combustion engine (1) are activated.

3. The method as claimed in claim 2, characterized in that, in order to prevent the occurrence of pre-ignition, a temperature in a combustion chamber of the combustion engine (1) is lowered.

4. The method as claimed in claim 3, characterized in that the temperature in the combustion chamber of the combustion engine (1) is lowered by a fuel enrichment in the combustion engine (1).

5. The method as claimed in claim 3, characterized in that the temperature in the combustion chamber of the combustion engine (1) is lowered by an air enrichment in the combustion engine (1).

6. The method as claimed in claim 3, characterized in that the temperature in the combustion chamber of the combustion engine (1) is decreased by lowering the charging of the combustion engine (1) by reducing the air supply.

7. The method as claimed in claim 3, characterized in that the temperature in the combustion chamber of the combustion engine (1) is decreased by reducing an internal residual gas in the combustion engine (1) by reducing the overlap of the timing of an inlet (15) and an exhaust valve (16) of the combustion engine (1).

8. The method as claimed in claim 16, characterized in that, in order to diagnose the sensor (17), standardized reference levels are determined from the sensor signal and are compared with an upper and a lower threshold value in order to detect a fault, a fault being detected if the sensor signal lies outside the signal band formed by the upper and the lower threshold value.

9. The method as claimed in claim 16, characterized in that, in order to diagnose the sensor cable (24), a short-circuit test is carried out and, if a short circuit of the sensor cable (24) to a battery voltage or to an earth is present, a fault is detected.

10. The method as claimed in claim 16, characterized in that the diagnosis of the sensor signal evaluation device (20) is carried out by monitoring the computer hardware with respect to signal capture and signal evaluation, a fault being detected if implausibilities have occurred during the signal capture or signal evaluation.

11. The method as claimed in claim 8, characterized in that the fault is stored in an error memory for evaluation in a workshop.

12. A device for setting an emergency operational mode in a system which detects pre-ignition in a combustion engine and which contains faults, wherein, in order to detect a fault, the system, which consists of at least one sensor (17) and/or at least one sensor cable (24) and/or a sensor signal evaluation device (20), is subjected to a diagnosis, characterized in that an evaluator (18, 25) is present which, upon detection of a fault in the system (17, 24, 20) by the diagnosis, interrupt or completely or partially switch off a standard path (26), comprising sensor signal capture, sensor signal evaluation, detection of pre-ignition and initiation of measures to counter pre-ignition, and activate a safety path (27) as an emergency operational mode.

13. The device as claimed in claim 12, characterized in that the evaluator includes a control and evaluation device (18) for the combustion engine (1) which triggers signals for a diagnosis of the at least one sensor (17) and/or the at least one sensor cable (24) and/or the sensor signal evaluation device (20) and evaluates the response signals received in dependence on these signals, the standard path (26) for detecting pre-ignition being interrupted and the safety path (27) being activated upon detection of a fault.

14. The device as claimed in claim 12, characterized in that the sensor (17) is a knock sensor arranged on the cylinder of the combustion engine (1), a pressure sensor arranged in the combustion chamber of the combustion engine (1) or a rotational speed sensor detecting the rotational speed of the crankshaft of the combustion engine (1).

15. The device as claimed in claim 12, characterized in that each cylinder of the combustion engine (1) has as actuators an inlet valve (15) for admitting air and an exhaust valve (16) for discharging a combustion waste gas, the opening times of which are set by a respective camshaft, the control and evaluation device (18) activating the camshaft in such a way that the opening times of the inlet (15) and exhaust valve (16) do not overlap or overlap only slightly.

16. The method as claimed in claim 1, wherein the system at least one sensor (17) and/or a sensor cable (24) and/or a sensor signal evaluation device (20).

17. The method as claimed in claim 1, wherein the standard path (26) of the system (17, 24, 20) includes-sensor signal capture, sensor signal evaluation, detection of pre-ignition and initiation of measures to counter the pre-ignition.

18. The method as claimed in claim 1, wherein the standard path (26) is interrupted or completed or partially switched off.

19. The method as claimed in claim 3, characterized in that the temperature in the combustion chamber of the combustion engine (1) is decreased by reducing an internal residual gas in the combustion engine (1) by reducing the overlap of the timing of an inlet (15) of the combustion engine (1).

20. The method as claimed in claim 3, characterized in that the temperature in the combustion chamber of the combustion engine (1) is decreased by reducing an internal residual gas in the combustion engine (1) by reducing the overlap of the timing an exhaust valve (16) of the combustion engine (1).
